(19) United States
(12) Patent Application Publication
(10) Pub. No.: US 2007/0026216 A1
(43) Pub. Date: Feb. 1, 2007

(54) Acoustic element consisting of composite foam

(75) Inventors: Rudolph Weingartner, Seewalchen am Attersee (AT); Ulf Panzer, Perg (AT); Dietmar Rammer, Engerwitzdorf (AT)

Correspondence Address: WILLIAM COLLARD;COLLARD & ROE, P.C., 1077 NORTHERN BOULEVARD, ROSLYN, NY, 11576, US

(73) Assignee: GREINER PERFOAM GMBH, Kremsmunster (AT)

(21) Appl. No.: 10/549,093

(22) PCT Filed: Mar. 12, 2004
(86) PCT No.: PCT/AT04/00089

§ 371 Date: Sep. 20, 2006

(30) Foreign Application Priority Data
Mar. 14, 2003 (DE) 103 11 245.6

(51) Int. Cl. B27N 3/00; B32B 3/26

(52) U.S. Cl. 428/304.4; 264/109; 264/121

(57) ABSTRACT

The invention relates to an acoustic component (1) of composite foam and a method of producing an acoustic component (1) comprising particles (2) or bars (11) of plastic foam, which are bound to one another by a binding agent (5). The particles (2) or bars (11) have surfaces (4) made up of flat and/or curved part-surfaces. Cavities (7) are formed in the acoustic component (1) between the particles (2) or bars (11).

The invention relates to an acoustic component of composite foam and a method of producing an acoustic component of the type outlined by the features contained in the introductory parts of claims 1 respectively 27.

EP patent 0 657 266 B1 discloses a device and a method of producing moulded parts from foam. In this instance, floccules or granulates are produced from recycled plastic waste in a shredding machine, cutting or breaking machine or a mill or similar, and admixed with a liquid raw material of a plastic, as a result of which the surface of the floccules of the plastic waste or recycled plastic is coated with the liquid raw material. Having been coated in this manner, the floccules are then blown into a mould cavity until the volume of the mould cavity is filled with the floccules, after which the reaction of the raw material is triggered by applying pressure and/or temperature and/or steam, and the floccules thus joined to one another by a cohesive cellular structure of the binding agent or primary material. The materials of the floccules used for this method may be “PUR” (polyurethane) soft foam waste, PUR cold and/or hot mould foam waste, PUR soft foam waste with textiles and/or coated or lined film, PUR composite foam waste but also rubber granulates or cork granulates, with the addition of thermoplastic waste and/or natural and/or synthetic fibres of various lengths as well. This method enables the mould cavity to be filled with a uniform density as the materials are introduced and offers the possibility of adapting the density ratios in individual cross-sectional regions of the moulding. Due to the granular-type structure or irregular external shape of the floccules of plastic foam, the floccules in mouldings of this type are deposited virtually without gaps and a compact filling of the entire volume of the moulding is achieved due to the floccules.

Patent specification DE 694 25 044 T2 describes an agglomerated polyurethane foam and a method of producing such a polyurethane foam, which primarily consists of soft polyurethane foam particles. The particles bound to one another by size are produced from pieces of the soft polyurethane foam obtained by processing with a cutting machine. The starting material is soft polyurethane foam with a density of from 12 to 50 kg/m³. After admixing with the size, the particles are compressed, after which the size is cured in the compressed state. Essentially dust-free polyurethane foam particles are used, with a volume of 0.15 to 25 cm³, and the agglomerated polyurethane foam finally has a density of 15 to 50 kg/cm³. The agglomerated polyurethane foam is used as a filling material, for example in cushions or mattresses.

The objective of the invention is to propose an acoustic component of composite foam.

This objective is achieved by the invention on the basis of the acoustic component defined by the features in the characterising part of claim 1. The advantage of this approach is that because of the cavities disposed between the particles bound by the binding agent, the degree of noise absorbed by the resultant acoustic components is increased. Namely, sound enters the interior of a cavity of the acoustic component 1, causing multiple reflections on the internal surfaces, thereby absorbing sound energy as the reflection on the internal surface is converted into heat.

The embodiments of the acoustic component defined in claims 2 and 3 are of advantage insofar as at least approximately prismatic or cylindrical or at least approximately bar-shaped particles can be produced relatively easily by machine from recycled plastic waste, for example, and offer a good capacity for adapting to volume during processing.

The embodiment of the acoustic component defined in claim 4 is of particular advantage. As the particles are cut from plastic foam, very little dust is generated during their production, which means that only a small proportion of binding agent containing a synthetic material or of binding agent is needed to join the particles to form an acoustic component.

The advantage of the embodiments of the acoustic component defined in claims 5 and 6 is that acoustic components can be made which have a curve of sound absorption level largely corresponding to the noise generated by motor vehicles.

As specified in claim 7, the particles used to produce an acoustic component have a volume of between 0.003 cm³ and 1.5 cm³, in particular from 0.003 cm³ to 0.15 cm³. The advantage of this is that complex acoustic component geometries can be produced with small particles of this type.

The advantage of the embodiment of the acoustic component defined in claim 8, whereby the particles are at least approximately quadrangular and have a volume or side lengths in the range of from 0.1 cm×0.1 cm×0.5 cm to 0.4 cm×0.4 cm×2, is that complex acoustic component geometries can be produced with such small particles and a higher proportion of cavities is also formed in the acoustic component during production due to the bar-shaped particles.

Also of advantage are the embodiments of the acoustic component defined in claims 9 to 12, because they enable the production of acoustic components adapted to the frequency curve of the noise generated by a specific sound source.

As specified in claim 13, the proportion of the total volume of cavities between particles corresponds to a value of from 0% to 25% of the total volume of the acoustic component. The advantage of this is that the acoustic component can be made sufficiently strong whilst at the same time also increasing the degree of noise absorption.

Also of advantage is the embodiment defined in claim 14, whereby the binding agent accounts for a proportion of between 3% and 25% of the total weight of the acoustic component and, because the proportion of binding agent is kept correspondingly low, the acoustic components can be produced inexpensively.

Also of advantage is the embodiment of the acoustic component defined in claim 15, whereby the binding agent accounts for a proportion of between 5% and 15% of the total weight of the acoustic component, because cavities with a correspondingly large volume are formed between the particles but the particles can still be bound with sufficient strength at the same time.

The embodiment defined in claims 16 to 18 advantageously results in an effective and sufficiently strong bond between the particles.

Also of advantage are the embodiments defined in claims 19 and 20, whereby the particles are embedded in a curved or elastically deformed state and the particles of the acoustic component are embedded in the cellular structure of the plastic foam in the binding agent in a state in which they are elastically compacted to a smaller volume than their free foam volume, because the internal tension or biassing of the particles achieved as a result increases the mechanical stiffness of the acoustic component.

The advantage of the acoustic component defined in claim 21 is that the external shape of acoustic component lends itself sufficiently well to shaping, e.g. for automotive parts. The specified particle size means that the particles mixed with binding agent are deposited so efficiently in the moulds used as standard that even relatively small or thinly structured regions of the acoustic component are filled with particles and result in the same particle density as other regions.

The embodiment of the acoustic component defined in claim 22, whereby different densities are produced in different volume regions of the acoustic component is of advantage firstly because the acoustic properties can be influenced and secondly because different mechanical strengths can be obtained, which can therefore facilitate assembly of the acoustic component.

Also of advantage are the embodiments of the acoustic component defined in claims 23 and 24, because the volume of cavities between the particles in different volume regions of the acoustic component may differ, thereby making a broader frequency spectrum accessible for sound absorption specific based on frequency.

The advantage of the integral design of the acoustic component defined in claim 25 is that production is easier and more cost-effective and handling is also easier during assembly and subsequent use.

Also of advantage is the embodiment of the acoustic component defined in claim 26, because the acoustic component is provided with a facing moulded onto it and such components may be produced as cladding parts with a visible surface formed by the facing.

The objective of the invention is also independently achieved on the basis of a method of manufacturing an acoustic component incorporating the features defined in the characterising part of claim 27. The advantage of this approach is that by blowing the particles mixed with the binding agent in the conveying stream of a gaseous medium into a mould designed to produce the acoustic component, the density as well as the proportion of cavities formed in the acoustic component can be pre-defined and selected from within a relatively broad range.

The fact that the volume of the mould is reduced prior to initiating curing of the binding agent, as is the case with the embodiment of the method defined in claim 28, has an advantage in that the proportion of cavities and the particle density may be varied in part-regions of the volume of the acoustic component.

The embodiment defined in claim 29 is also of advantage because the proportion of dust in the particles is lower, as a result of which relatively small quantities of binding agent will suffice in producing the acoustic components.

Other advantageous embodiments of the method are specified in claims 30 to 35.

To provide a clearer understanding, the invention will be described in more detail below with reference to the appended drawings.

These are simplified, schematic diagrams as follows:

FIG. 1 is a perspective diagram showing an acoustic component of composite foam;

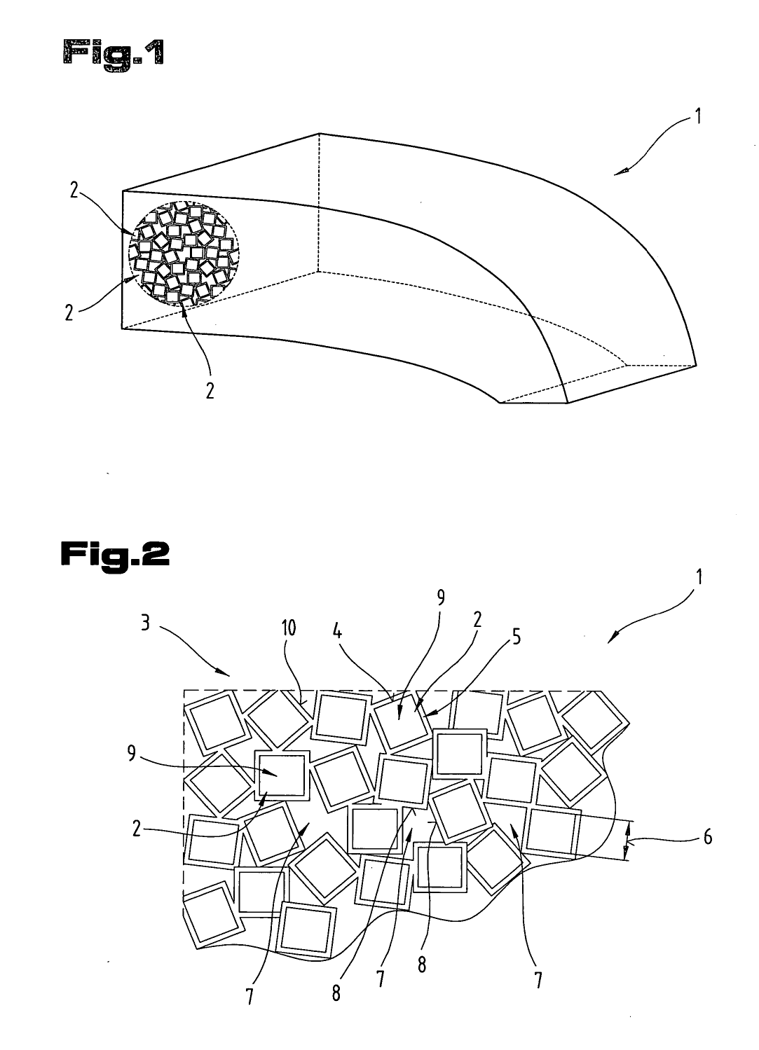

FIG. 2 shows a detail of the acoustic component illustrated in FIG. 1 on a larger scale;

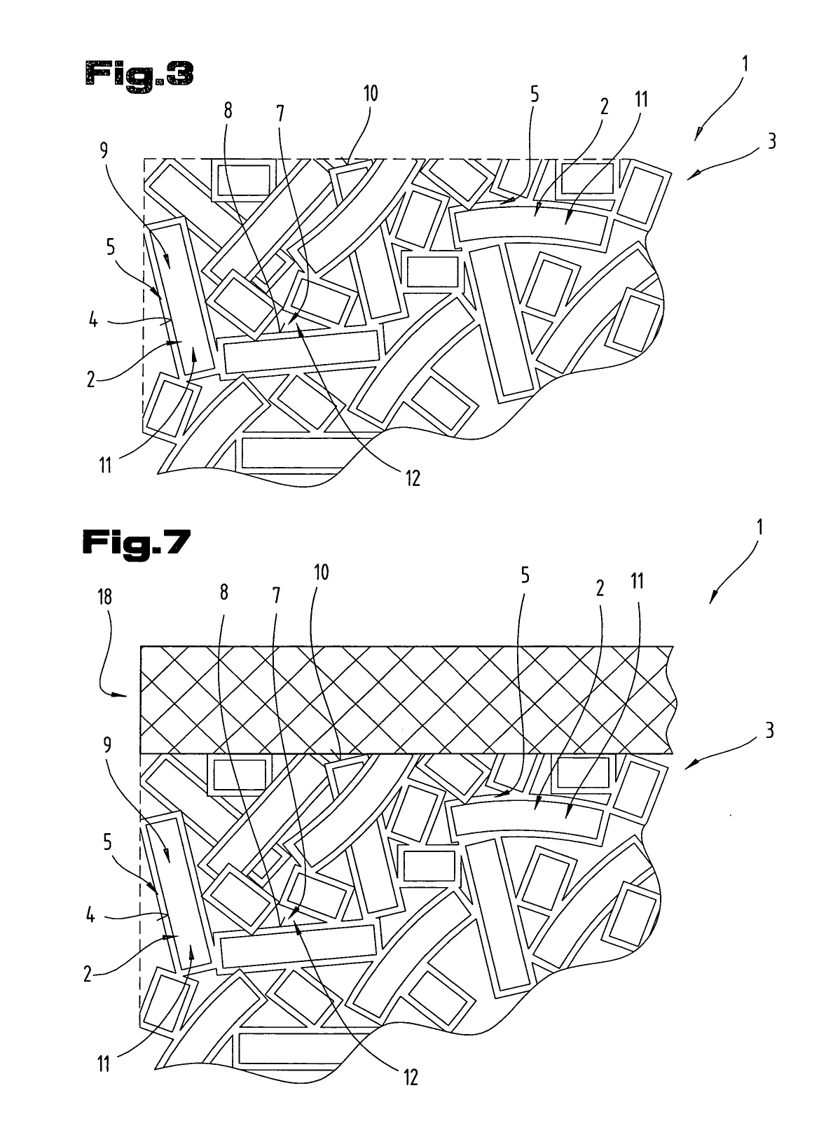

FIG. 3 is a detail, shown in section, of another example of an embodiment of an acoustic component with bar-shaped particles;

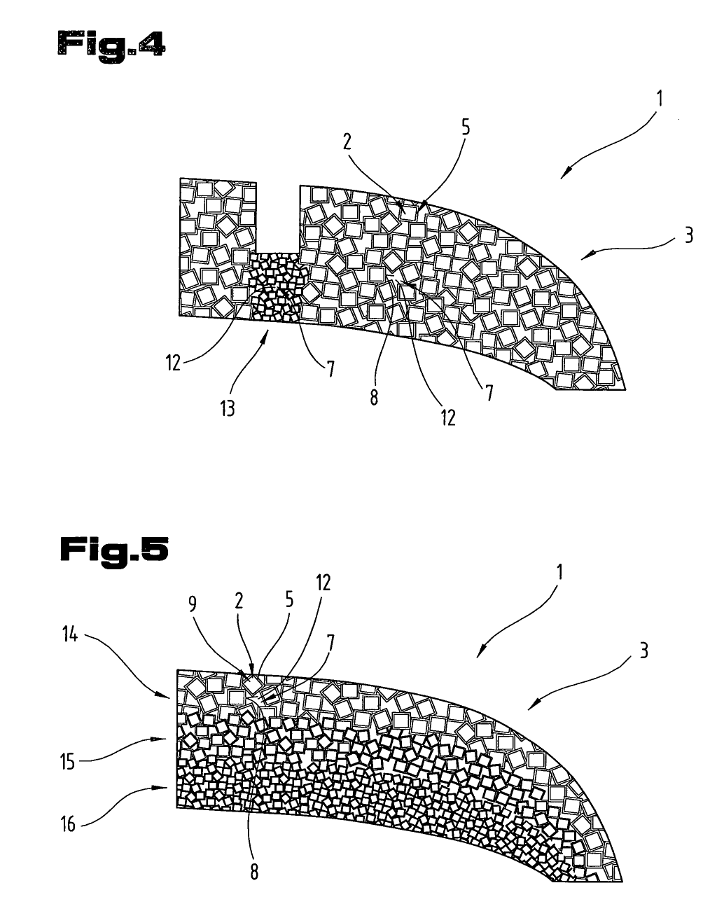

FIG. 4 is a cross-section through an acoustic component with a higher density in one region;

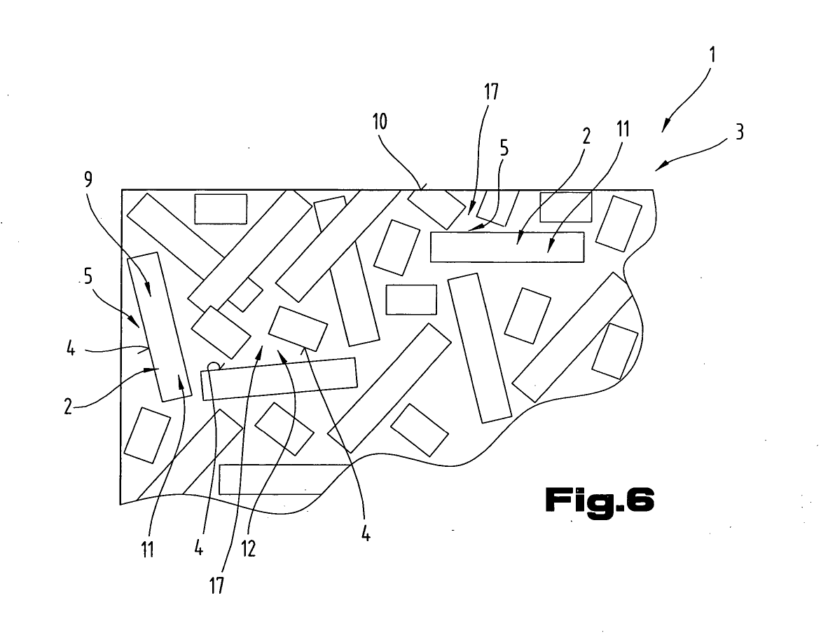

FIG. 5 is a section showing a cross-section through an acoustic component with a layered structure;

FIG. 6 is a section showing a detail of an example of an embodiment of the acoustic component with bar-shaped particles with gaps filled by the binding agent;

FIG. 7 is a section showing a detail of another example of an embodiment of an acoustic component with a facing;

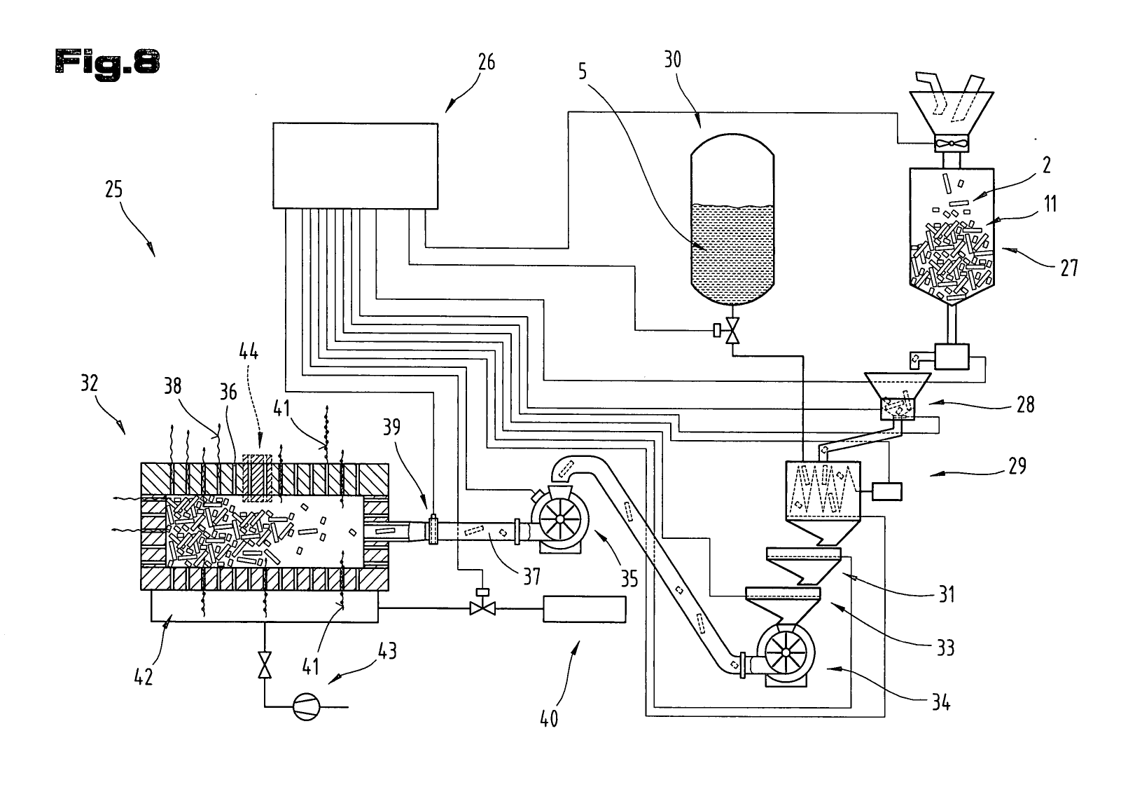

FIG. 8 is a simplified, schematic diagram showing a plant for producing an acoustic component as proposed by the invention.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc,. relate to the drawing specifically being described and can be transposed in terms of meaning to a new position when another position is being described. Individual features or combinations of features from the different embodiments illustrated and described may be construed as independent inventive solutions or solutions proposed by the invention in their own right.

FIG. 1 is a perspective view illustrating an acoustic component 1 made from composite foam.

The acoustic component 1 illustrated in FIG. 1 is a part which may be used in the interior of motor vehicles as a cladding element, for example. However, the acoustic component 1 may also be used for filling cavities of other components or parts, for example.

The internal structure of the composite foam of the acoustic component 1 is formed by particles 2 of plastic foam. This is shown on a simplified basis in FIG. 1 by the detail shown in a circle.

FIG. 2 shows a detail of the acoustic component 1 illustrated in FIG. 1 on a larger scale. A volume 3 of the acoustic component 1 is filled by irregularly oriented particles 2. The surfaces 4 of the particles 2 are coated with a binding agent 5 made from plastic. The binding agent 5 reacts so that it is cured or polymerised to a plastic foam, as a result of which respective particles 2 lying against one another are bound to one another by the binding agent 5 to form a cellular structure. The particles 2 are thus bound to form a solidly joined acoustic component 1.

It would naturally also be possible for the surface 4 of the particles 2 not only to be completely coated with binding agent 5 but also only partially coated. This may be the case in particular if the proportion of binding agent in terms of quantity is low compared with the total weight of the acoustic component 1 or if a totally even distribution of the binding agent 5 between the particles 2 is not obtained when the particles 2 are mixed with the binding agent 5.

The acoustic component 1 is produced from the particles 2 and the binding agent 5 in a manner known per se, for example using the method specified in patent specification EP 0 657 266 B1, whereby the particles 2 are firstly mixed with a liquid binding agent 5 so that their surface is coated with the binding agent 5 and the particles 2 are then blown into a specially designed mould cavity, after which the reaction of the binding agent is triggered, causing it to solidify and bind the particles 2 by means of a cohesive cellular structure.

In the embodiment illustrated as an example in FIGS. 1 and 2, at least approximately cuboid particles 2 are used. An edge length 6 of the cuboid particles 2 has a value of approximately 0.4 cm. The particles 2 are obtained by cutting appropriate materials using cutting machines. As a result, the particles 2 have more or less flat surfaces 4. The cutting machines used to produce the particles 2 are preferably of the type by means of which a cross-section of at least the same size can be imparted to the particles 2. This also means that the particles obtained will be virtually regular and as far as possible of the same size. Another advantage of using cutting technology is that little dust is generated during production and the particles 2 contain only a low proportion of dust. During production of the acoustic component 1, the process of mixing the particles 2 and blowing them into a specially provided mould will result in a virtually totally irregular orientation and abutment of the particles 2. If the proportion of binding agent 5 used is also correspondingly small, this will be conductive to creating cavities 7 in the acoustic component 1. The cavities 7 are respectively created by internal surfaces 8 of the binding agent 5 surrounding the particles 2 and in the case where the surface 4 of the particles 2 is not completely coated with binding agent, bounded by part-regions of the surfaces 4 of the particles 2.

The formation of cavities 7 in the acoustic component 1 is promoted by the low proportion of dust between the particles 2. Another advantage of the low proportion of dust in the particles 2 is that the proportion of binding agent 5 can be kept very low because only a small amount of binding agent 5 is needed to wet the dust particles and the biggest proportion of the binding agent 5 is available for wetting the surfaces 4 of the particles 2.

The cavities 7 formed between the particles 2 improve sound absorption by the acoustic component 1. The sound absorption level (a=absorbed energy/incident energy) is used to characterise sound absorption. It is a known phenomenon that sound entering a cavity generally loses energy due to multiple reflections on the walls of the cavity, because the sound energy is converted to heat due to the friction taking place in the particles of the walls and in the gaseous medium which exists in the cavities. In the same way, sound is absorbed accordingly in the cavities 7 in the acoustic component 1. Sound entering the acoustic component 1 is partially reflected and partially transmitted on the boundary surfaces formed by the surfaces 8 of the binding agent 5. When sound enters the interior of such a cavity 7, it is reflected at various points on the surfaces 8 of the cavity 7 and thus leads to the described energy loss or sound absorption. The sound waves passing between the cavities 7 and the particles 2 and cured binding agent 5 always causes lattice vibrations of the atoms, which represents a dissipative energy element, the energy of which is drawn from the sound and the random movement of the atoms is thus converted into heat energy. This effect is enhanced accordingly by the multiple reflections of the sound on the surfaces 8 of the cavity 7 and thus contributes to the sound absorption. Forming such cavities 7 in the acoustic component 1 therefore improves the acoustic properties in terms of sound insulation and sound absorption.

By selecting differently sized particles 2 or different lengths 6 of the cubes of the particles 2 for different acoustic components 1, the volume of the cavities 7 also varies, which means that the sound absorption can be selectively pre-determined for specific frequencies. However, the volume of the cavities 7 is also influenced by the proportion of binding agent 5 with which the particles 2 are coated and pre-selecting the proportion of binding agent 5 therefore likewise offers a possibility of determining sound absorption with respect to specific frequencies. The edge length 6 of the cuboid particles 2 is selected so that a volume 9 of the particles 2 has a value in the range of 0.05 cm³ to 1.5 cm³. The volume 9 is preferably selected from a range of 0.1 cm³ to 0.15 cm³. Another specific advantage of using such small particles 2 is that acoustic components 1 with a surface 10 having a corresponding lower surface roughness can also be produced, without the need for a separate process to finish the surface 10. Using such small particles 2 also means that acoustic components 1 can also be made with a relatively finely structured external shape. Finely structured regions of the external shape of such an acoustic component 1 can be produced by introducing the particles 2 into a mould provided as a means of producing an acoustic component 1 from the particles 2 and the latter can be filled by them. A surface roughness is imparted to the external surface 10 of the acoustic component 1 based on a value corresponding to a size classification of the particle size. The surface roughness of the acoustic component 1 has a value in the range of from 0.1 cm to 0.5 cm. Due to the surface roughness, the external shape of the acoustic component 1 has a bigger surface area than a flat external surface 10, which likewise increases sound absorption.

FIG. 3 illustrates a detail of another embodiment of an acoustic component 1 with bar-shaped particles 2, viewed in section. In this embodiment, the particles 2 are provided in the form of bars 11. The volume 3 of the acoustic component 1 is formed or filled by irregularly oriented bars 11. The bars 11 are coated with the binding agent 5, which is cured and the cohesive cellular structure of which binds the mutually adjacent bars 11 to form a three-dimensional structure. Cavities 7 are again formed between the bars 11. The bars 11 are quadrangular in shape and have side lengths of 0.3 cm×0.3 cm×1.5 cm. Using bars 11 for the particles 2 results in the production of an acoustic component 1 in which the volume 12 of the cavities 7 accounts for a higher proportion of the total volume 3 of the acoustic component 1 because the bars 11 are not deposited as densely against one another as cuboid particles 2 during the production process. The bars 11 are produced by a cutting machine, which can be set up so that their volume 9 and the side lengths are in a range of from 0.1 cm×0.1 cm×0.5 cm to a volume 9 or side lengths of 0.4 cm×0.4 cm×2 cm.

As illustrated in FIG. 3, some of the bars 11 are deformed or curved. This is caused by the production process, whereby the bars 11 admixed with binding agent 5 are packed into a mould and the bars 11 are pushed against one another to differing degrees depending on the pressure applied during filling, resulting in an elastic deformation of the bars 11. After curing or reacting the binding agent 5, the particles 2 or bars 11 remain embedded in the acoustic component 1 in a curved or elastically deformed state. This firstly reduces the volume 9 of the cavities 7 and secondly causes an internal tension in the bars 11 and the acoustic component 1. This internal tension increases the mechanical stiffness of the acoustic component 1 and thus influences its acoustic properties.

It would naturally also be possible to use bars 11 with a shape other than that of a quadratic cross-section to produce the acoustic component 1. In addition to a rectangular or circular cross-section, it would also be conceivable to use bars 11 with a different, at least almost cylindrical or prismatic shape, e.g. particles 2 with a triangular or hexagonal cross-section. Particles 2 of a plate-shaped design could also be used.

Generally speaking, 1 particles 2 with a surface 4 incorporating flat and/or curved part-surfaces would be suitable for producing the acoustic component 1 proposed by the invention. Surfaces 4 of this type result in cavities 7 with the sharpest possible boundaries between the particles 2 in the acoustic component 1. By contrast with plastic floccules of the type produced by cutting up recycled plastic in shredding machines or mills, the surfaces 4 of the particles 2 have no or only a small proportion of fraying. Such fraying of the plastic floccules in conjunction with the binding agent 5 leads to agglutination, as a result of which virtually no cavities 7 are formed. Such fraying or protruding regions of the plastic floccules have a slimmer material thickness than the core regions of the plastic floccules and can therefore be elastically deformed more easily, as a result of which protruding frayed regions of mutually adjacent plastic floccules are able to interlock with one another. The plastic floccules therefore have an outer deformation zone to a certain degree, which means that mutually adjacent plastic floccules may lie more densely against one another. Ultimately, it may be of advantage for part-surfaces of the surfaces 4 of the particles 2 to be of a concave design because this will mean that the total volume of the cavities 7 will be greater as a proportion of the total volume of the acoustic component 1. Particles 2 in the shape of spherical half-shells or tubular sections would be possible, for example. The acoustic components 1 are preferably produced with a proportion of the total volume of the cavities 7 accounting for range of 0% to 25% of the total volume of the acoustic component 1.

As explained above, forming cavities 7 in the acoustic component 1 between the bars 11 or particles 2 improves acoustic properties in terms of improved sound absorption. Sound entering a cavity 7 is reflected several times on the internal surfaces 8 of the binding agent 5, with which the bars 11 are coated, causing sound energy to be dissipated.

FIGS. 4 and 5 illustrate examples of embodiments of acoustic components 1 which have a different density in different volume areas of the composite foam, viewed in section. Using known devices for producing acoustic components of plastic foam, such as described in patent specification EP 0 547 266 B1 for example, it is possible to obtain a locally higher compaction of the composite foam made from the particles 2 and binding agent 5.

FIG. 4 illustrates a cross-section of an acoustic components 1 with a higher density in a region 13. The particles 2 in region 13 are in an elastically compacted state, in which they are embedded and thus firmly secured by the cellular structure of the cured binding agent 5 of the plastic foam. The particles 2 in region 13 therefore occupy a volume which is smaller than their free foam volume would be, i.e. than their volume would be if they were not in the elastically deformed state. The higher density in region 13 is associated with both a higher mechanical strength and with a smaller volume 12 of cavities 7. However, the smaller cavities 7 mean that the acoustic properties are different from the other regions in the volume 3 of the acoustic component 1.

FIG. 5 illustrates a cross-section of an acoustic component 1 with a layered structure, viewed in section. Certain regions of the volume in the acoustic component 1 comprise layers 14, 15 and 16. Due to a multi-stage production process, the particles 2 in layers 14, 15, 16 are compressed to different degrees so that the density of the composite foam in layer 15 is higher than the density in layer 14 and the density in layer 16 is higher than that in layer 15. However, as a result of compression during the production process, the volume 12 of the cavities 7 in the different layers 14, 15 and 16 also varies and hence the corresponding acoustic properties, i.e. the frequency-specific sound absorption is extended across a correspondingly broader frequency band. In layers 14, 15 and 16 of the acoustic component 1, the cavities 7 formed between the particles 2 differ in terms of their density by volume. By controlling the production process accordingly, however, it is also possible to vary the amount of binding agent 6 of the composite foam in layers 14, 15 and 16 of the acoustic component 1. In other words, the density of the binding agent 5 in different layers 14, 15 and 16 of the acoustic component 1 varies.

The material used for the particles 2 to produce the acoustic components 1 may be mixed with one another in any pre-definable ratio and may include PUR (polyurethane) soft recycled foam, PUR cold and/or hot mould recycled foam, PUR soft recycled foam with textiles and/or coated or lined with film, PUR composite recycled foam, but also granulated rubber or rubber or cork granulates. To produce the acoustic components 1, particles 2 may be used with a density in the range of from 15 kg/m³ to 70 kg/m³. The particles 2 preferably have a mass or density in a range of from 70 kg/m³ to 1.600 kg/m³.

The composite foam of the acoustic components 1 proposed by the invention may have a density in the range of from 40 kg/m³ to 300 kg/m³; in particular, the acoustic components 1 have a density in the range of from 60 kg/m³ to 200 kg/m³. It is also possible to produce lightweight acoustic components 1 with a density in a range of from 60 kg/m3 to 70 kg/m3, medium-weight acoustic components 1 with a density in a range of from 70 kg/m3 to 130 kg/m3 and heavy acoustic components 1 with a density in a range of from 130 kg/m3 to 200 kg/m3. This enables the acoustic components 1 to be specifically adapted to the frequency curve of noise generated from a specific sound source. Various prepolymers of plastic foams may be used for the binding agent 5. A particularly suitable binding agent is polyurethane or polyurethane foam, such as soft foam or a hot-mould foam. One particularly suitable binding agent is a polyurethane size based on a prepolymer of TDI and/or MDI with ether polyols, for producing soft PU foams. The polyurethane size may specifically contain up to 25% free NCO groups. To produce the acoustic component 1, the binding agent 5 is used in a proportion ranging from 4% to 25% of the total weight of the acoustic component 1. By preference, a proportion of from 5% to 15% of binding agent is used by reference to the total weight of the acoustic component 1.

FIG. 6 shows a detail of an example of an embodiment of an acoustic component 1 with bar-shaped particles 2 or bars 11 with the binding agent 5 filling the gaps 17, viewed in section. If a plastic foam is used as the binding agent 5 or size, an increase in volume is obtained during production of the acoustic component 1 due to the reaction of the binding agent, so that the gaps 17 between the particles 2 are completely filled by the binding agent 5. If a binding agent 5 is used which has a different density from the particles 2 once the reaction is complete, a sound-absorbing effect of the type described in connection with the cavities 7 illustrated in FIGS. 2 to 5 is also imparted to these gaps 17. Since the particles 2 on the one hand and the binding agent 5 on the other hand have a different density, the surfaces 4 of the particles 2 constitute boundary surfaces, on which the sound can be reflected. Sound penetrating the acoustic component 1 is reflected on these surface 4 a number of times, as a result of which sound energy is converted into heat due to friction.

If the density of the material of the particles 2 is higher than the density of the binding agent 5, the sound-absorbing effect described in connection with the cavities 7 illustrated in FIGS. 2 to 5 is imparted to the gaps 17. Conversely, if the density of the binding agent 5 is higher than the density of the material of the particles 2, the effect of the cavities 7 illustrated in FIGS. 2 to 5 is imparted to the volume 12 of the bars 11 or particles 2. Due to the selective use of a binding agent 5 with a different density from the density of the bars 11 or particles 2, therefore, the acoustic properties can likewise be improved and the sound-absorbing effect of acoustic components 1 enhanced.

In another example of an embodiment of an acoustic component 1, it would naturally also be possible to form cavities 7 in addition to gaps 17 completely filled with binding agent 5. Sound reflections within the meaning of the sound-absorbing effect described above can also be achieved at continuous density transitions in the material of the acoustic component 1 and not just at sharp changes in density transitions, such as those which occur at the surfaces 4 and 8 formed by the boundary surfaces.

FIG. 7 illustrates a detail of another example of an embodiment of an acoustic component 1 with a facing 18, viewed in section. In the region of the surface 10 of the acoustic component 1, a facing 18 is joined to the particles 2 or bars 11 by an on-moulding process. The facing 18 may be provided in the form of a fibre mat, a fibre non-woven fabric, a woven fabric, a lattice, a netting or a film. However, the facing 18 may itself also be formed from a composite foam and form what might be termed a heavy layer. Such a facing 18 may be produced by shredding hard plates of already pre-compacted material, e.g. EPDM, and these particles are bound in the conventional manner with a polyurethane foam to form a new block from which heavy layers are cut for example. This being the case, it is also possible for a facing 18 of this type constituting a heavy layer to be made in a multi-stage process directly in the mould provided for production purposes. A facing 18 forming a heavy layer could also be produced from granulated rubber. An acoustic component 1 with a facing 18 of this type could be used as an internal cladding component for motor vehicles.

FIG. 8 is a simplified, schematic diagram illustrating a plant 25 for producing the acoustic component 1 (FIG. 1) proposed by the invention. In order to control the process sequence for producing the acoustic component 1, a control unit 26 is provided. The particles 2 or bars 11 are taken from a storage container 27 and, after establishing the requisite quantity in a weighing device 28, delivered to a mixing device 29, where they are mixed with a binding agent 5 drawn from a storage container 30 and then transported to an intermediate storage container 31. The quantity of binding agent 5 mixed with the particles 2 or bars 11 needed to fill a mould 32 is then determined in another weighing device 33 and then introduced by means of a conveyor mechanism 34 and a conveyor fan 35 into the mould 32.

The mould 32 is provided with venting orifices 36 so that the particles 2 or bars 11 transported by the conveyor flow 37 of a gaseous medium generated by the conveyor fan 35 can be blown into the mould, whilst the gaseous medium is able to escape from the mould 32 as indicated by arrow 38. The degree to which the particles 2 or bars 11 are pressed into and against one another in the mould 32 may be pre-set both by the pressure of the conveyor flow 37 generated by the conveyor fan 35 and by a control drive 39 disposed between the conveyor fan 35 and the mould 32.

In order to trigger or accelerate the process of curing the binding agent 5, steam produced in a heat exchanger 40 is delivered through the venting orifices 36 as indicated by arrow 41 and can be removed again through a discharge passage 42 by means of a vacuum pump 43. Once the particles 2 or bars 11 have been blasted into the mould 32 under pressure in the conveyor stream of a gaseous medium, curing can then proceed by applying steam and/or allowing the reaction to continue to completion.

In another embodiment of the method proposed by the invention, the volume of the mould 32 is reduced after filling it with the particles 2 mixed with the binding agent 5, after which the process of curing the binding agent 5 is initiated. This may be achieved by providing the mould 32 with a displaceable mould insert 44 (indicated by broken lines). Once the filling process is terminated, this mould insert 44 can be pressed into the mould 32, as a result of which particles 2 at least in a region adjacent to the mould insert 44 are compacted, as illustrated in FIG. 4, for example.

For the sake of good order, finally, it should be pointed out that in order to provide a clearer understanding of the structure of the acoustic component 1, it and its constituent parts are illustrated to a certain extent out of scale and/or on an enlarged scale and/or on a reduced scale.

The objective underlying the independent inventive solutions may be found in the description.

Above all, the individual embodiments of the subject matter illustrated in FIGS. 1, 2; 3; 4; 5; 6; 7; 8 constitute independent solutions proposed by the invention in their own right. The objectives and associated solutions proposed by the invention may be found in the detailed descriptions of these drawings.

### List of Reference Numbers

1 Acoustic component
2 Particle
3 Volume
4 Surface
5 Binding agent
6 Edge length
7 Cavity
8 Surface
9 Volume
10 Surface
11 Bar
12 Volume
13 Region
14 Layer
15 Layer
16 Layer
17 Gap
18 Facing
25 Plant
26 Control unit
27 Storage container
28 Weighing device
29 Mixing device
30 Storage container
31 Intermediate storage container
32 Mould
33 Weighing device
34 Conveyor mechanism
35 Conveyor fan
36 Venting orifice
37 Conveyor flow
38 Arrow
39 Control drive
40 Heat exchanger
41 Arrow
42 Discharge passage
43 Vacuum pump
44 Mould insert

1. Acoustic component (1) of composite foam comprising particles (2) or bars (11) of plastic foam, which are bonded to one another by means of a binding agent (5), wherein the particles (2) or bars (11) are of an at least approximately prismatic shape and have surfaces (4) formed by flat and/or curved part-surfaces and cavities (7) are formed between the particles (2) or bars (11).

2. Acoustic component (1) as claimed in claim 1, wherein the particles (2) or bars (11) are of an at least approximately prismatic or cylindrical shape.

3. (canceled)

4. Acoustic component (1) as claimed in claim 1, wherein surfaces (4) of the particles (2) or bars (ii) are produced by cutting.

5. Acoustic component (1) as claimed in claim 1, wherein the particles (2) or bars (ii) have a density with a value in the range of from 15 kg/m³to 70 kg/m³.

6. Acoustic component (1) as claimed in claim 1, wherein the particles (2) or bars (11) have a density with a value in the range of from 70 kg/m³to 1,600 kg/m³.

7. Acoustic component (1) as claimed in claim 1, wherein the particles (2) or bars (ii) have a volume (9) with a value in a range of from 0.003 cm³ to 1.5 cm³, in particular from 0.003 cm³ to 0.15 cm³.

8. Acoustic component (1) as claimed in claim 1, wherein the particles (2) or bars (11) are at least approximately quadrangular in shape with a volume (9) or edge lengths (6) in a range of from 0.1 cm×0.1 cm×0.5 cm to 0.4 cm×0.4 cm×2 cm.

9. Acoustic component (1) as claimed in claim 1, wherein the acoustic component (1) has a density with a value in a range of from 60 kg/m³ to 200 kg/m³.

10. Acoustic component (1) as claimed in claim 1, wherein the acoustic component (1) has a density with a value in a range of from 60 kg/m³ to 70 kg/m³.

11. Acoustic component (1) as claimed in claim 1, wherein the acoustic component (1) has a density with a value in the range of from 70 kg/m³ to 130 kg/m³.

12. Acoustic component (1) as claimed in claim 1, wherein the acoustic component (1) has a density with a value in the range of from 130 kg/m³ to 200 kg/m³.

13. Acoustic component (1) as claimed in claim 1, wherein a total volume of the cavities (7) represents a proportion with a value in the range of from 0% to 25% of a volume (3) of the acoustic component (1).

14. Acoustic component (1) as claimed in claim 1, wherein the binding agent (5) represents a proportion with a value in a range of from 3% to 25% of the total weight of the acoustic component (1).

15. Acoustic component (1) as claimed in claim 1, wherein the binding agent (5) represents a proportion with a value in a range of from 5% to 15% of the total weight of the acoustic component (1).

16. Acoustic component (1) as claimed in claim 1, wherein the binding agent (5) is polyurethane, in particular a polyurethane foam.

17. Acoustic component (1) as claimed in claim 1, wherein the binding agent (5) is a soft foam.

18. Acoustic component (1) as claimed in claim 1, wherein the particles (2) or bars (11) of plastic foam are bonded by means of a cellular structure of binding agent (5).

19. Acoustic component (1) as claimed in claim 1, wherein the particles (2) or bars (11) are embedded in a curved or elastically deformed state.

20. Acoustic component (1) as claimed in claim 1, wherein the particles (2) or bars (11) of plastic foam are embedded in the cellular structure of the binding agent (5) in an elastically compacted state occupying a smaller volume than that of their free foam volume.

21. Acoustic component (1) as claimed in claim 1, wherein an external surface (10) of the acoustic component (1) has a surface roughness corresponding to a value of a particle size.

22. Acoustic component (1) as claimed in claim 1, wherein different regions in the volume, in particular layers (14, 15, 16), of the acoustic component (1) have a different density.

23. Acoustic component (1) as claimed in claim 1, wherein different regions in the volume, in particular layers (14, 15, 16), of the acoustic component (1) have a different density by volume of cavities (7).

24. Acoustic component (1) as claimed in claim 1, wherein different regions in the volume, in particular layers (14, 15, 16), of the acoustic component (1) have a different mean density of binding agent (5).

25. Acoustic component (1) as claimed in claim 1, wherein the acoustic component (1) is of an integral design.

26. Acoustic component (1) as claimed in claim 1, wherein a facing (18) is joined to the particles (2) or bars (11) in the region of the surface (10) of the acoustic component (1).

27. Method of producing an acoustic component (1) from particles (2) or bars (11) of plastic foam, whereby the particles (2) or bars (11) are admixed with a liquid binding agent (5) and superficially coated, after which they are blasted in the conveyor stream of a gaseous medium at a pressure into the mould (32), which is provided with venting orifices (36) to allow the gaseous medium to flow out, and bound to a cohesive cellular structure, after which steam is applied if necessary and/or the reaction is left to terminate, in particular to produce an acoustic component (1) as claimed in claim 1, wherein the particles (2) or bars (11) used are of an at least approximately prismatic shape and have surfaces (4) made up of flat and/or curved part-surfaces and the particles (2) or bars (11), and a quantity of the binding agent (5) and/or the pressure of the gaseous medium is selected so that cavities (7) are formed between the particles (2) or bars (11).

28. Method as claimed in claim 27, wherein the volume of the mould (32) once filled with the particles (2) or bars (ii) admixed with binding agent (5) is reduced in at least certain regions and curing of the binding agent (5) is then initiated.

29. Method as claimed in claim 27, wherein surfaces (4) of the particles (2) or bars (11) are produced by cutting.

30. Method as claimed in claim 27, wherein particles (2) or bars (11) are used which have a density with a value in a range of from 15 kg/m³ to 70 kg/m³.

31. Method as claimed in claim 27, wherein particles (2) or bars (11) are used which have a density with a value in a range of from 70 kg/m³ to 1,600 kg/m³.

32. Method as claimed in claim 27, wherein particles (2) or bars (11) are used which have a volume (9) with a value in a range of from 0.003 cm³ to 1.5 cm³, in particular from 0.003 cm³ to 0.15 cm³.

33. Method as claimed in claim 27, wherein for the quantity of binding agent (5), a proportion with a value in a range of from 3% to 25% of the total weight of the acoustic component (1) is selected.

34. Method as claimed in claim 27, wherein a prepolymer with a base of MDI is used as the binding agent (5).

35. Method as claimed in claim 27, wherein the particles (2) or bars (11) are embedded in the binding agent (5) in a curved or elastically deformed state.
